(19) United States
(12) Patent Application Publication
(10) Pub. No.: US 2026/0329878 A1
(43) Pub. Date: Oct. 22, 2026

(54) SYSTEMS AND METHODS FOR AUTOMATIC REFINING OF LLM PROMPTS

(71) Applicant: ServiceNow, Inc., Santa Clara, CA (US)

(72) Inventors: Yash Saxena, Santa Clara, CA (US); Erez Katz, Portland, ME (US); Ziaul Hasan Hashmi, Seattle, WA (US); Srivatsava Daruru, San Jose, CA (US)

(21) Appl. No.: 19/181,819

(22) Filed: Apr. 17, 2025

(51) Int. Cl. G06F 16/248; G06F 16/2457; G06N 3/08

(52) U.S. Cl. CPC G06F 16/248; G06F 16/24578; G06N 3/08

(57) ABSTRACT

This disclosure is directed to a system and a method for refining an LLM prompt. In an embodiment of this disclosure, the method may be practiced by retrieving a user query from a dataset of user queries and receiving a first prompt. Then the method includes generating, via a language mode, a candidate response based on the first prompt and the user query. The method includes determining error levels associated with the candidate response via a plurality of judge models. The method includes generating a second prompt based on the first prompt and the error levels. Lastly, the method includes generating, via the language model, an updated response based on the second prompt.

### TECHNICAL FIELD

The present disclosure relates generally to systems and methods for automatically generating and refining LLM prompts.

### BACKGROUND

A virtual assistant system may include or interface with pre-trained large language models (LLMs) and/or a retrieval mechanism (e.g., Retrieval-Augmented Generation (RAG)) to improve responses to a user query. For example, a stock prompt may not generate the most effective response from the LLM. Instead, the stock prompt may generate inaccurate, lengthy, and/or incomplete responses. Accordingly, additional prompts may be provided to the trained LLM to enable the trained LLM to generate a response that appropriately addresses the user query. Processing these additional prompts cause the trained LLM to utilize more computational resources. Furthermore, the additional prompts may generate even less effective responses, requiring additional iterations to determine a best prompt.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of this disclosure, a method may be practiced by retrieving a user query from a dataset of user queries, receiving a first prompt, generating a candidate response based on the first prompt and the user query via a language model, determining a plurality of error levels associated with the candidate response via a plurality of judge models, generating a second prompt based on the first prompt and the plurality of error levels, and generating an updated response based on the second prompt via the language model.

In an embodiment of this disclosure, a system may include processing circuitry and a non-transitory memory accessible by the processing circuitry. The non-transitory memory may store instructions that, when executed by the processing circuitry, cause the processing circuitry to perform operations including: retrieving a user query from a dataset of user queries, receiving a first prompt, generating a candidate response based on the first prompt and the user query via a language model, determining a plurality of error levels associated with the candidate response via a plurality of judge models, generating a second prompt based on the first prompt and the plurality of error levels, and generating an updated response based on the second prompt via the language model.

In an embodiment of this disclosure, a non-transitory, computer readable medium includes instructions that, when executed by processing circuitry, cause the processing circuitry to perform operations including: retrieving a user query from a dataset of user queries, receiving a first prompt, generating a candidate response based on the first prompt and the user query via a language model, determining a plurality of error levels associated with the candidate response via a plurality of judge models, generating a second prompt based on the first prompt and the plurality of error levels, and generating an updated response based on the second prompt via the language model.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables a client instance that hosts a prompt refining tool, in accordance with aspects of the present disclosure;

FIG. 5 is a block diagram of a process for iteratively refining an LLM prompt, via the prompt refining tool of FIG. 4, in accordance with aspects of the present disclosure;

FIG. 6 is a block diagram of a process for generating, via the prompt refining tool of FIG. 4, an updated prompt based on error levels within a response associated with an original prompt, in accordance with aspects of the present disclosure;

FIG. 7 is a block diagram of a process for conducting a multi-response evaluation, via the prompt refining tool of FIG. 4, in accordance with aspects of the present disclosure;

FIG. 8 is a block diagram of a process for evaluating a single response via a set of judge models, in accordance with aspects of the present disclosure;

FIG. 9 is a block diagram of a process for categorizing error levels associated with a response, via the prompt refining tool of FIG. 4, in accordance with aspects of the present disclosure; and

FIG. 10 is a flow chart of a process for automatically refining a prompt to generate a response, via the prompt refining tool of FIG. 4, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Prompt engineering is an iterative manual process wherein AI-generated responses to a prompt are evaluated to identify deficiencies and the prompt is refined to mitigate the deficiencies. Prompt engineering may rely on manual adjustments to prompts, which may fail to improve the prompt and may be time and labor intensive. Accordingly, new techniques for prompt engineering are needed.

Various embodiments disclosed herein are directed to a system and method for iteratively refining AI prompts autonomously. The computing system may retrieve a dataset of queries and context from a database. In some embodiments, the computing system may split the dataset into a first subset for training a model and a second subset for testing the responses of the model. The computing system may receive a first prompt. In some embodiments, the prompt may include one of the queries, the context, and instructions for instructing an LLM on how to generate a response. The computing system may provide the first prompt and the first subset of the dataset to the LLM to generate one or more responses.

The computing system may then analyze and evaluate the responses. As an example, the computing system may determine a validation score based on a comparison of the responses to the second subset of the dataset to check the accuracy of the model. In some embodiments, the computing system may analyze the responses, via a language model, to determine if the query is answerable. If the computing system determines the query is unanswerable, the computing system may end the process without outputting a response. If the computing system determines the query is answerable, the computing system may analyze the responses via a set of judge models to determine one or more error levels associated with the responses. Each of the judge models may be a separate and distinct LLM trained to evaluate the responses for a particular metric. For example, the metrics may include formatting (e.g., markdown compliance), accuracy of citations, completeness of response, conciseness of response, groundedness (e.g., hallucination detection, accuracy of information in response), relevance to the query, self-referential statements, false No Answer Found (NAF) (e.g., incorrectly identifying no answer exists), and the like. Additionally, the computing system may determine a training score based on a comparison of the responses to the first subset of the dataset. Once the judge models have determined the error levels for each response, the computing system may provide any response with an associated error level into one or more error models. The error models may summarize each error level and organize the error levels into the error categories for each metric. The computing system may quantify the occurrences of error levels for each error category. The computing system may identify one or more categories with the most occurrences as frequent error levels.

The computing system may generate a second prompt via a prompt generation model based on the frequent error levels. In particular, the prompt generation model may be configured to generate a second prompt that mitigates the frequent error levels. The computing system may provide the second prompt and the first subset of the dataset to the LLM to generate a second one or more responses. The computing system may repeat the process (e.g., response analysis and evaluation, prompt generation) until an nth prompt outputs responses where the difference between a validation score of the responses and training score of the responses are not within a threshold amount of each other. The computing system may then output responses associated with a prompt preceding the nth prompt to a user interface.

The embodiments of this disclosure may provide an automated system for self-refining conversational AI prompts. As such, the system may reduce manual operations and improve the language model's performance for a variety of user queries. For example, the system may improve response accuracy, minimize hallucinations, and ensure responses are comprehensive and coherent. As an example, the system may ensure accuracy of responses and avoids overfitting responses to training data by comparing the responses to the validation data and the training data and outputting a response with relatively high values for both sets of data. By identifying a user query as unanswerable before submitting the response to evaluation via the set of judge models, the system may increase the efficiency of the process and reduce resource consumption (e.g., conserve computational resources). Additionally, the evaluation of each response for each metric via the set of judge models may ensure the system detects each error level in the response. The system may additionally generate error categories to encompass similar error levels and generate a new prompt based on the most frequent error categories, thereby addressing the most reducing error levels in the response to the new prompt while increasing efficiency of the system and reducing resource consumption. The process may be iterative such that the system minimizes the error levels in a response with each iteration while increasing the accuracy, comprehensiveness, and coherence of the response. As such, the system may improve the language model's performance for each user query.

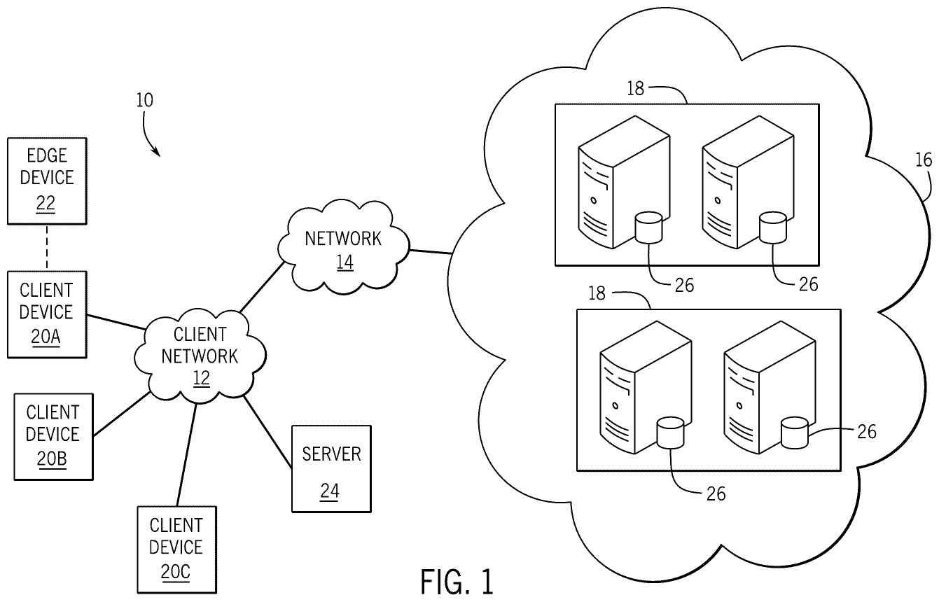

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IOT) devices that access cloud computing services, for example, via a web browser application or via an edge device 22 that may act as a gateway between the client devices 20 and the platform 16. FIG. 1 also illustrates that the client network 12 includes an administration or managerial application, device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

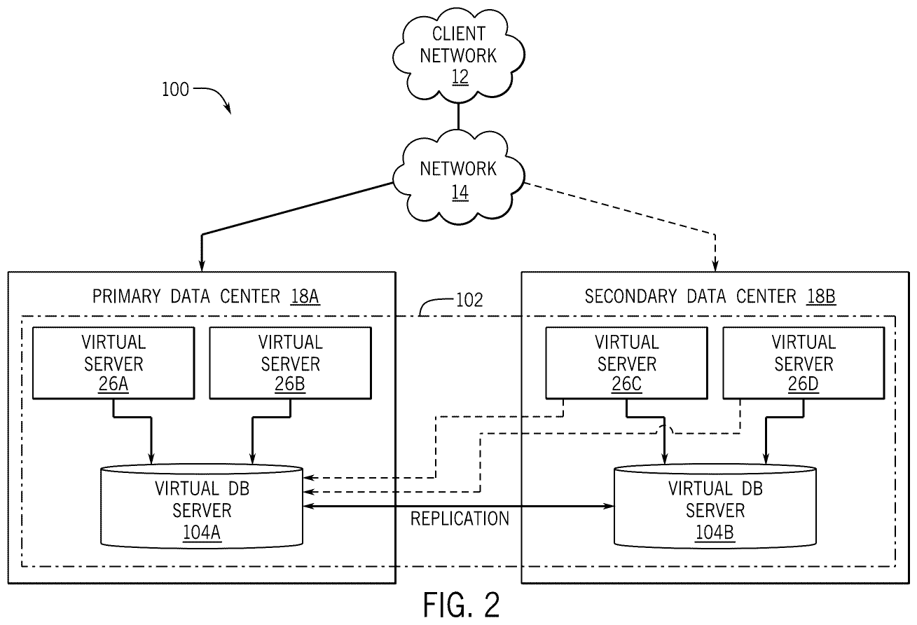

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

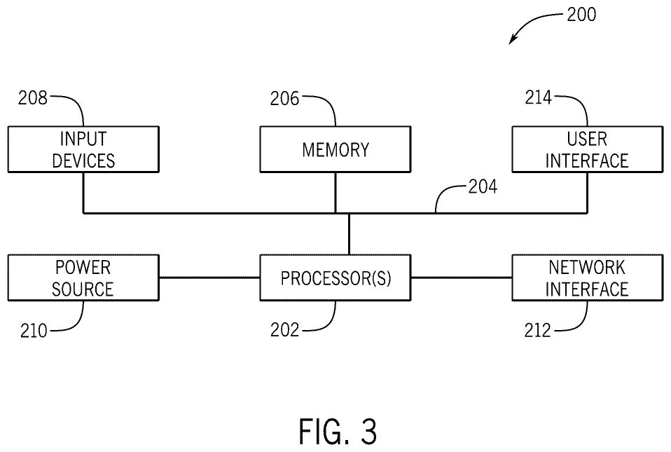

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

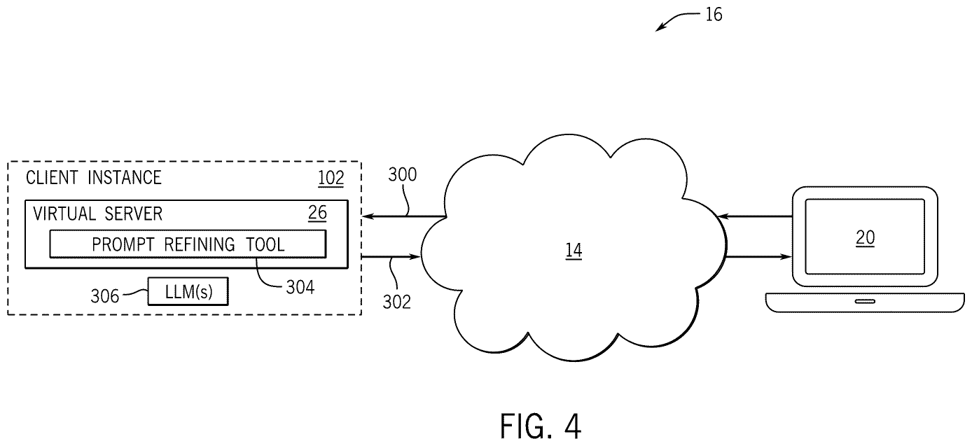

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). The client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in FIG. 4, the virtual server 26 of the client instance 120 may run a prompt refining tool 304, which may be a software application defined by code, accessible via a native application or web browser of the client device 20. Accordingly, the inputs 300 may include inputs such as a user query, context (e.g., client specific documents, business process model and notation (BPMN) conventions, industry standard operating procedures, industry best practices, publicly available information, publications, data from the Internet, etc.), a prompt, and so forth. Correspondingly, the outputs 302 may include responses to inputs 300, summary of prompt refining process, updated prompts, error levels, responses, and feedback generating during the prompt refining process, and so forth. The prompt refining tool 304 may utilize one or more large language models 306 (LLMs), which may be stored within the client instance 102 or accessible to the client instance 102, to generate some or all of the outputs 302. As used herein, a large language model (LLM) is a probabilistic model of a natural language used for general-purpose language generation. LLMs typically include one or more artificial neural networks having a transformer-based architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks associated with prompt refining, as well as tasks beyond the scope of prompt generation and modification.

The presently disclosed prompt refining tool 304 receives natural language inputs and uses the LLMs 306 to automatically generate and refine prompts based on the inputs. As used herein, “natural language” is intended as language, either written, typed, or spoken by a human being. Accordingly, a natural language input may be one or more human-readable alphanumeric character strings, or audio, the meaning of which may be understood by a human. As shown in FIG. 4, the prompt refining tool 304 may receive a natural language input 300 (e.g., the user query) from the client device, such as “I would like to summarize the attached documents.” The prompt refining tool 304 utilizes the one or more LLMs 306 to generate a response as an output 302. The one or more LLMs 306 may be trained, for example, on the dataset of records of multi-turn conversational interactions (e.g., user queries and/or context), which may be sourced from client specific documents, transcripts, publicly available information, publications, data from the Internet, and so forth. In some embodiments, the one or more LLMs 306 may be “off the shelf” or “out of the box” LLMs 306 provided by a service provider and not unique to the client instance 102. However, in other embodiments, the LLMs may be customized to the client instance 102, either with specific training, specific customized settings, or both.

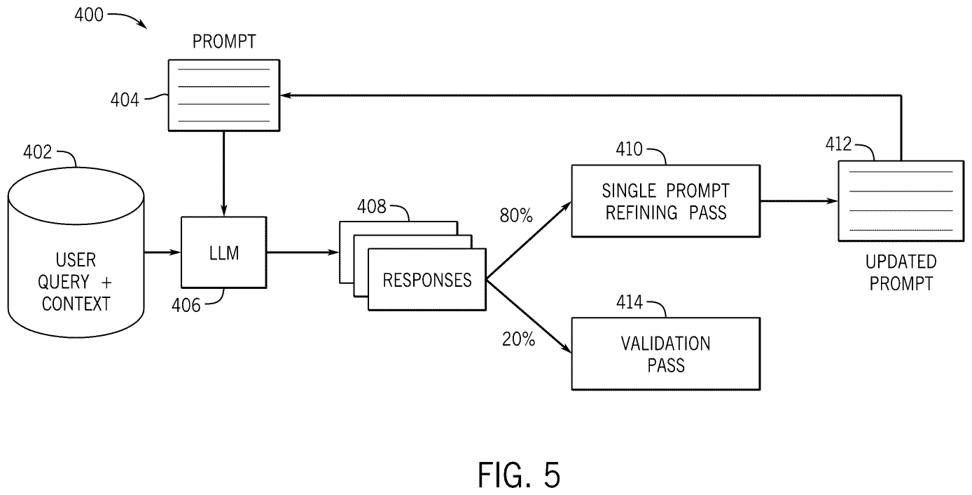

FIG. 5 is a block diagram of a process 400 for iteratively refining an LLM prompt, in accordance with aspects of the present disclosure. As such, the process 400 may repeat (i.e., iterate) certain steps. For example, the process 400 may generate responses for a first prompt and evaluate the responses to generate a second prompt. The process 400 may generate second responses for the second prompt and evaluate the second responses to generate a third prompt. The process 400 may continue to repeat. Thus, the process 400 may iteratively refine the first prompt.

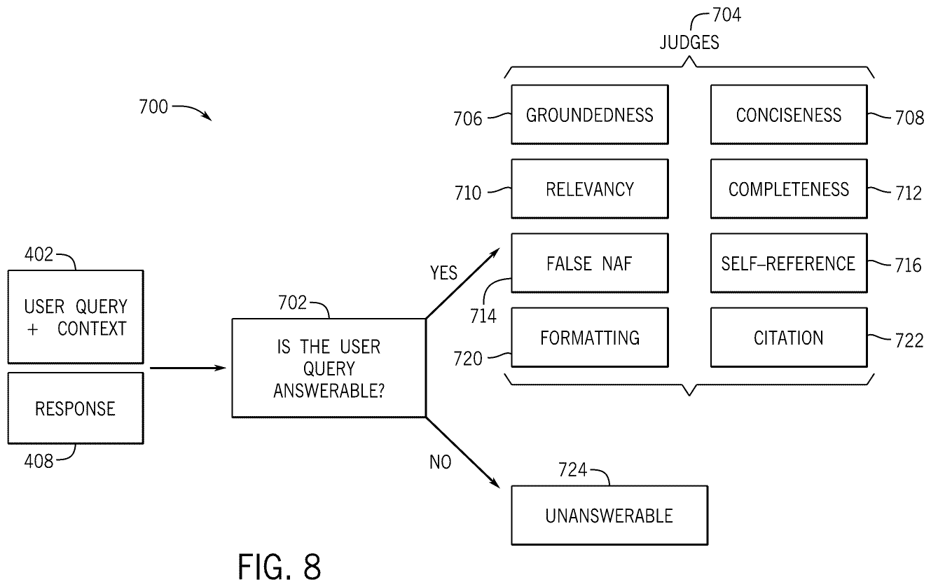

The computing system 10 may retrieve a dataset of user queries and/or context 402 from a database. User query may refer to any textual input from a user into a language model. For example, a user query may include “What is my 401(k) contribution limit?”, “Please summarize the meeting notes.”, “Am I pretty?”, and “Thank you.” As discussed below with regard to FIG. 8, the user query may not necessarily be answerable. The context may refer to documents that provide information that may be used to answer the user query. The context may include client specific documents, business process model and notation (BPMN) conventions, industry standard operating procedures, industry best practices, publicly available information, publications, data from the Internet, and the like. For example, the context for the example user queries above may include a company's 401(k) policies, meeting notes, and a picture respectively. In some embodiments, the context may be packaged with, appended to, or otherwise included with the user query. The computing system 10 may utilize the user query and/or the associated context 402 to refine a prompt.

Additionally, the computing system 10 may split the dataset 402 into a first subset of user queries (e.g., a training set) and a second subset of user queries (e.g., a validation set). The computing system 10 may train the first LLM 406 on the first subset The computing system 10 may use the second subset to validate responses output by the first LLM 406 as described below. Thus, the computing system 10 may validate that the responses that are output are not overfit to the training data.

To initiate the process 400, the computing system 10 may receive a first prompt (e.g., an original prompt) 404.

The first prompt 404 may include the user query and/or the context 402 and instructions for the first LLM 406 on how to respond to the user query. For example, the first prompt 404 may include instructions for what indicates a user query is unanswerable, proper formatting, which sources to consult, citations, any assumptions the model should or should not make, and the like. In some embodiments, the computing system 10 may receive the first prompt from the client device 20.

The computing system may provide a user query and context of the dataset 402, the first prompt 404, or any combination thereof to the first LLM 406. The first LLM 406 may generate one or more responses 408 to the user query based on the user query and context 402 and/or the first prompt 404. In some embodiments, the computing system 10 may generate a response for each user query within the dataset. Alternatively, the computing system 10 may generate one response for each of a subset of user queries within the dataset.

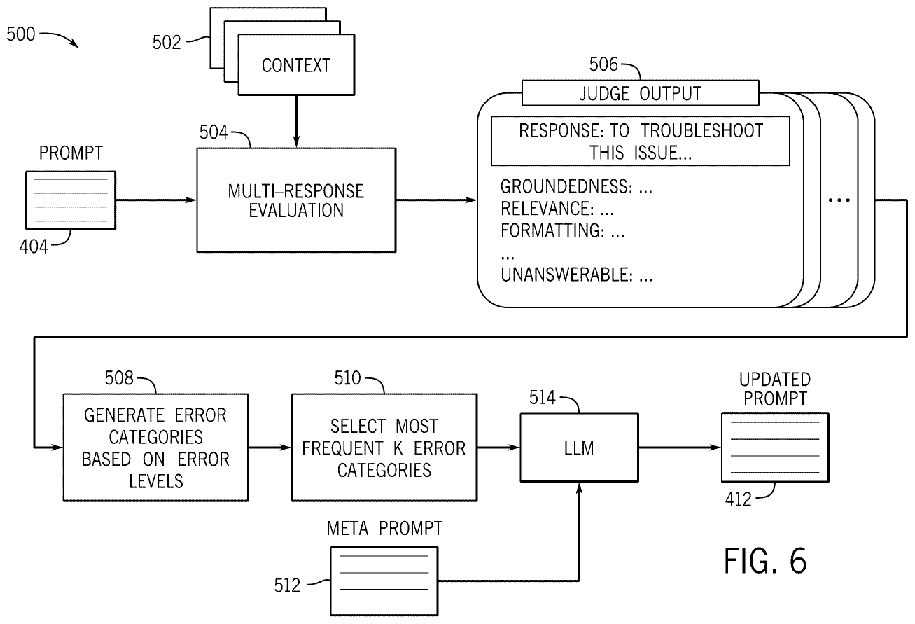

The computing system 10 may conduct a refining pass 410 with each of the one or more responses 408. The refining pass 410 may include evaluating each of the one or more responses 408 via a set of judge models and identifying the most frequent error levels associated with the responses 408 as discussed further in FIG. 6. Using the most frequent error levels, the refining pass 410 may generate an updated prompt 412 (e.g., a second prompt, an improved prompt). The computing system 10 may provide the updated prompt 412 to the first LLM 406 to generate one or more updated responses such that the computing system 10 repeats the process 400.

Additionally, the computing system 10 may conduct a validation pass 414 for each of the one or more responses 408. The validation pass 414 may include generating a validation score based on a comparison of each of the one or more responses 408 to the second subset of the dataset. A response with a low validation score may be indicative of overfitting, an issue that arises in machine learning applications when a model has been trained to create a response that closely matches a training dataset such that the model cannot make accurate predictions regarding new and/or additional data. To avoid overfitting, the computing system 10 may stop the process 400 if it determines one or more of the responses 408 are below a threshold validation score. Additionally and/or alternatively, the computing system 10 may stop the process 400 if the validation score diverges from a training score by a threshold amount, as described below. The computing system 10 may then store a prompt associated with a previous iteration in a database. For example, if a validation score of a response to a fourth prompt is below the threshold validation score, the computing system 10 may store a third prompt.

FIG. 6 is a block diagram of a process 500 for generating an updated prompt based on error levels within a response associated with an original prompt (e.g., a refining pass for a single prompt), in accordance with aspects of the present disclosure. The computing system 10 may receive the prompt 404 as described with regard to FIG. 5. The computing system 10 may also retrieve context 502 from the database. As described above, the context 502 refers to documents that provide information that may be used to answer a respective user query within the database. For example, the context may include client specific documents, business process model and notation (BPMN) conventions, industry standard operating procedures, industry best practices, publicly available information, publications, data from the Internet, and the like. In some embodiments, the user query associated with the context 502 may be inserted into the prompt 404.

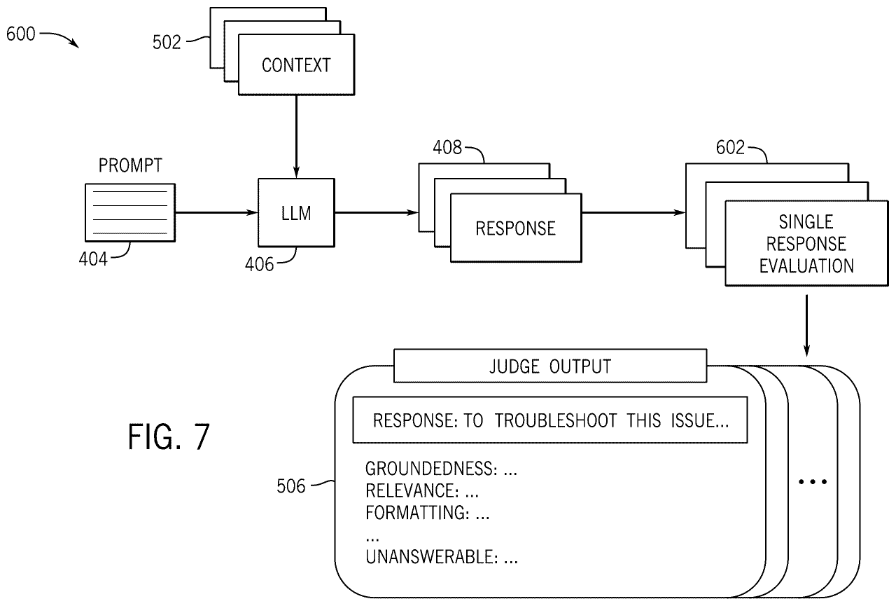

The computing system 10 may conduct a multi-response evaluation 504. As described further in FIG. 7, the multi-response evaluation 504 may include generating one or more responses via a first LLM based on the prompt 404 and the context 502. The computing system 10 may then conduct a single record evaluation for each response via a set of judge models to generate one or more judge outputs 506. As such, the computing system 10 may output the judge outputs 506 for each response as a result of the multi-response evaluation 504.

The one or more judge outputs 506 may include an indication of the response associated with each of the judge outputs 506. For example, the one or more judge outputs 506 may reproduce the associated response. The computing system 10 may generate a judge output 506 for each metric for each response. The metrics may include groundedness, relevance, formatting, citation, completeness, conciseness, and the like, as described further in FIG. 8. Each judge output 506 may include a list of error levels (e.g., errors, issues, defects, deficiencies, etc.) for each response. In some embodiments, the computing system 10 may generate one judge output 704 for each response including a list of error levels organized by metric. The list of error levels may be an in-depth textual description of error levels within the response. The description may include the error level, an indication of where the error level is in the response, a description of the error level, an explanation of why the response is deficient or unsatisfactory, any relevant sources, and the like. In some embodiments, the list of error levels may include numerical indications (e.g., quantitative metrics or measures) such as a number of error levels in the response, a severity level of the error levels, and the like. In some embodiments, the computing system 10 may generate a judge output 506 for each metric for each response. Each judge output 506 may also include an indication of whether the prompt 404 is answerable. Additionally, each judge output 506 may include a training score generated based on a comparison of the first subset of the dataset to the response. Moreover, each judge output 506 may include an assessment of the response based on the list of error levels. For example, the judge output 506 may indicate the response is unacceptable, acceptable, or ideal (e.g., optimal) based on the list of error levels. In some embodiments, the assessment may be based on the training score.

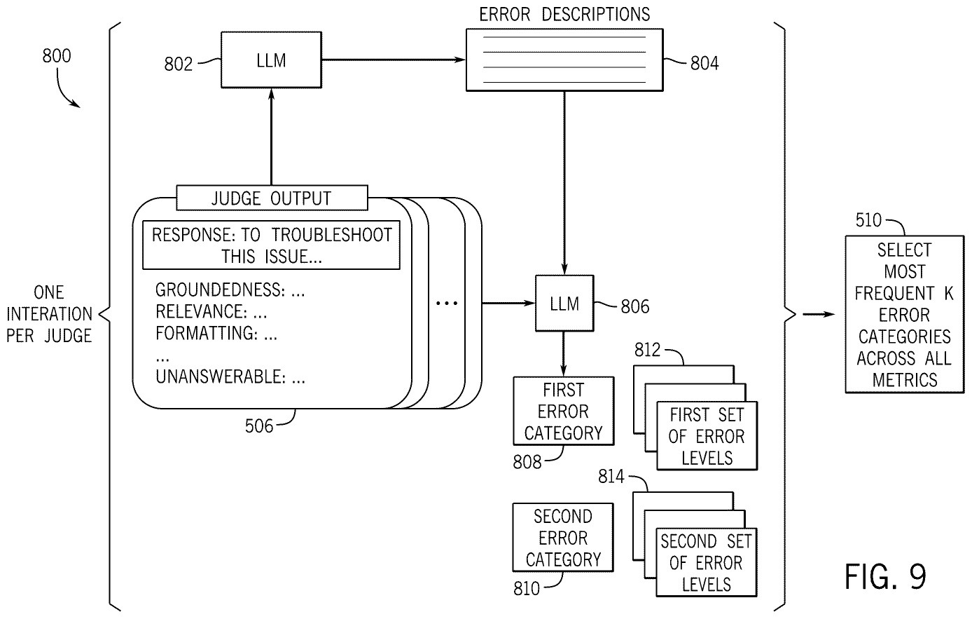

The computing system 10 may generate error categories based on the error levels 508. In particular, the computing system 10 may analyze the judge outputs 506 for all one or more responses to generate the error categories, as further described with regard to FIG. 9. An example of an error category may be incorrect citation or failure to use paragraph breaks. The computing system 10 may select the most frequent k error categories 510 (e.g., the error categories with the most error levels) across all responses.

In some embodiments, the computing system 10 may generate a meta prompt 512. For example, the computing system 10 may generate the meta prompt 512 based on the one or more judge outputs 506. The meta prompt 512 may include the prompt 404, the context 502, the responses to the prompt 404, or any combination thereof.

The computing system 10 may provide the most frequent k error categories 510 and the meta prompt 512 to a second LLM 514 (e.g., a second language model, a prompt generation model). The computing system 10 may generate an updated prompt 412 via the second LLM 514 based on the most frequent k error categories 510 and the meta prompt 512.

FIG. 7 is a block diagram of a process 600 for conducting a multi-response evaluation, in accordance with aspects of the present disclosure. The computing system 10 may receive a prompt 404. In some embodiments, the prompt 404 may contain a user query from the database. The computing system 10 may also retrieve context 502 from the database. The computing system 10 may provide the prompt 404 and the context 502 to the first LLM 406. The computing system 10 may generate one or more responses 408 via the first LLM 406 based on the prompt 404 and the context 502.

The computing system 10 may conduct a single response evaluation 602 for each of the one or more responses 408. The single response evaluation 602 may include providing each response 408 to a set of judge models. As a result of the single response evaluation 602, the computing system 10 may generate one or more judge outputs 506 corresponding to each of the one or more responses 408.

FIG. 8 is a block diagram of a process 700 for evaluating a single response 408 via a set of judge models 704 (e.g., a single response evaluation), in accordance with aspects of the present disclosure. In process 700, the computing system 10 may analyze a user query and/or context 402 and a response 408 to a prompt based on the user query and/or context 402.

Because the set of judge models 704 may only return sensible/logical feedback if the user query is designed to have an answer, the computing system 10 may first determine whether the user query is answerable 702. Unanswerable queries may include greetings (e.g., hello, good morning, etc.), ending the conversation (e.g., goodbye, later), gratitude (e.g., thanks, this is helpful), emotion (e.g., I hate you, I'm so embarrassed, I hope you break, etc.), non-factual statements or questions (e.g., am I pretty, praise me, do you like spinach), and the like. In some embodiments, the computing system 10 may be altered to include more or fewer user queries as unanswerable queries. The computing system 10 may determine the query is unanswerable based on feedback from a language model.

If the user query is answerable, the computing system 10 may provide the user query and/or context 402 and the response 408 to the set of judge models 704. The set of judge models 704 may be multiple language models, one language model, the first LLM, or a combination thereof.

The set of judge models 704 may evaluate the response 408 based on various respective pre-defined metrics. In some embodiments, each judge model of the set of judge models 704 may evaluate the response 408 based on a different metric. For example, the metrics may include groundedness 706, conciseness 708, relevancy 710, completeness 712, false no answer found 714, self-referential statements 716, formatting 720, and citation 722. Groundedness 706 may refer to a response's accuracy or lack of hallucinations; as such, the set of judge models 704 may evaluate the accuracy of the response 408 based on the user query and/or context 402 during a groundedness 706 evaluation. During a conciseness 708 evaluation, the set of judge models 704 may evaluate the brevity and redundancy of the response 408. During a relevancy 710 evaluation, the set of judge models 704 may evaluate whether the response 408 contains irrelevant information based on the user query. During a completeness 712 evaluation, the set of judge models 704 may evaluate whether the response 408 contains all required information based on the user query and the context 402. During a false no answer found 714 evaluation, the set of judge models 704 may evaluate whether the response 408 to the user query was incorrectly or falsely labeled as unanswerable. During a self-reference 716 evaluation, the set of judge models 704 may evaluate whether the response 408 contains references to the context (e.g., “according to the provided documents”). During a formatting 720 evaluation, the set of judge models 704 may evaluate whether the response 408 is formatted such that the information presented is easily ascertainable. During a citation 722 evaluation, the set of judge models 704 may evaluate the amount and accuracy of citations provided in the response 408.

As such, each of the set of judge models 704 may identify error levels in regard to the metrics and generate an assessment of the response based on the evaluation. For example, the set of judge models 704 may generate a training score based on a comparison of the response to the first subset of the dataset. Additionally, the set of judge models 704 may rate the response for each metric as “unacceptable”, “acceptable”, or “ideal” based on the evaluation. The computing system 10 may generate a list of error levels based on the identified error levels. In some embodiments, the list of error levels may be organized by metric. The list of error levels may contain each instance of an error level in the response 408 and a description of the error level. As discussed above, the computing system 10 may output a judge output for the response 408 including the assessment and the list of error levels.

If the user query is not answerable, then the computing system 10 may not provide the response to the set of judge models 704. Instead, the computing system 10 may output a judge output indicating no answer was found. In some embodiments, the computing system 10 may verify the user query is unanswerable. For example, the computing system 10 may provide the response to a variety of language models to verify each language model determines the user query is unanswerable.

FIG. 9 is a block diagram of a process 800 for categorizing error levels associated with one or more responses, in accordance with aspects of the present disclosure. The computing system 10 may generate the judge outputs 506 for each response as described above. The computing system 10 may filter out the judge outputs 506 that are assessed as ideal, assessed as acceptable, that have zero error levels, or any combination thereof. The remaining judge outputs 506 for the one or more responses may be separated into judge outputs 506 for each metric (“metric judge outputs 506”). Process 800 may be repeatedly iteratively for each metric.

The computing system 10 may provide the metric judge outputs 506 for the metric to a first error model 802 (e.g., a summation model, error LLM). The computing system 10, via the first error model 802, may summarize the list of error levels as error descriptions 804. The error descriptions 804 may be concise descriptions such as lack of citation for first sentence, missing date information, redundancy in third sentence, and so on.

The computing system 10 may provide the metric judge outputs 506 and the error descriptions 804 to the second error model 806 (e.g., categorization model, error LLM). In some embodiments, the first error model 802 and the second error model 806 may be a single error model. The computing system 10, via the second error model 806, may generate one or more error categories 808, 810 (e.g., 1, 2, 3, 4, 5 . . . categories). The categories may include similar types of error levels detected. For example, for the citation metric, the error categories may include lack of citation, incorrect citations, improper format of citations, and the like. As another example, for the groundedness metric, the error categories may include inaccurate information, out-of-date information, and the like. The error categories may include a category name, a short description, and an example of the error level. As an example, the category name may be “Lack of Citation” and the short description may be, for example, “failure to include a citation for a factual statement.” The example of the error level may be an error level from the list of error levels in the judge outputs. The computing system 10 may also, via the second error model 806, categorize each error level on the list of error levels into one of the error categories. As an example, as illustrated, the computing system 10 generates two error categories: a first error category 808 and second error category 810. The first error category 808 includes a first set of error levels 812, and the second error category 810 includes a second set of error levels 814. Each error category may include an indication of the categorized errors. For example, each error category may contain the textual description of the error level as included in the judge output 506 and/or the error description as output by the summation model 802. Additionally, the computing system 10 may quantify the numbers of error levels within each error category.

Once the computing system 10 has generated error categories for each metric and organized the error levels into the error categories, the computing system 10 may select the most frequent k error categories across all metrics 510 and across all the one or more responses based on the quantification of the error levels within the error categories. K in this context may refer to any appropriate constant value (e.g., 1, 2, 3, 4, 5, 6, 7, 8, and so forth). For example, the computing system 10 may select the most frequent five error categories.

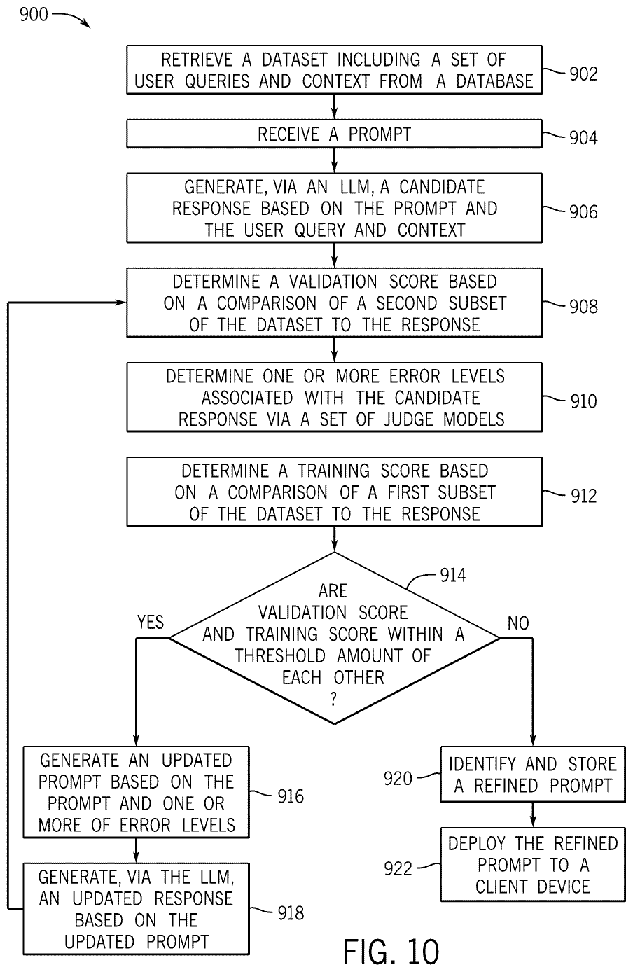

FIG. 10 is a flow chart of a method 900 for automatically refining a prompt to generate a response, in accordance with aspects of the present disclosure. The computing system 10 may perform the method 900 in response to receiving an input (e.g., receiving a user query and/or context, etc.). Although the following description of the method 900 is described in a particular order and being performed by the computing system 10, it should be noted that the method 900 may be performed in any suitable order and by any suitable processing system. Further, it should be understood that, though shown in a sequential or serial manner for the purpose of illustration and explanation, in practice certain of the steps of processes may be performed in parallel or in a multithreaded manner, which may be more efficient in terms of time, computational cycles or bandwidth, and/or computational resources.

In process block 902, the computing system 10 may retrieve a dataset including a set of user queries and context from a database. User queries may refer to any textual input from a user to a language model or LLM. The context may include client specific documents, business process model and notation (BPMN) conventions, industry standard operating procedures, industry best practices, publicly available information, publications, data from the Internet, and the like associated with the user queries. In some embodiments, the computing system 10 may split the dataset into subsets. As such, the computing system 10 may use a first subset (e.g., training data) to train an LLM (e.g., a language model) and a second subset (e.g., validation data) to validate the response generated by the LLM.

In process block 904, the computing system 10 may receive a prompt. The prompt may include instructions for instructing an LLM on how to respond to user query. The instructions may include instructions regarding the answerability of the user queries, available sources, assumptions for generating the responses, and requirements of the responses (e.g., accuracy, conciseness, formatting, citations, etc.). In some embodiments, the prompt may include the user query and the context.

In process block 906, the computing system 10 may generate, via the LLM, a candidate response based on the prompt and a user query from the dataset. In some embodiments, the computing system 10 may generate multiple responses based on the prompt and some or all of the user queries from the dataset.

In process block 908, the computing system 10 may determine a validation score for the candidate response based on a comparison of the candidate response to the validation data of the dataset. The validation score may be a numerical indicator (e.g., a percentage, a decimal, etc.) of how closely the response matches the validation data. As such, a higher validation score may indicate a better match between the response and the validation data. If the candidate response is within an upper limit validation score threshold, the computing system 10 may end the method 900 and output the candidate response to the client device 20. Thus, the computing system 10 may avoid generating extraneous responses, increasing the efficiency of the system and reducing resource consumption.

In process block 910, the computing system 10 may determine one or more error levels associated with the candidate responses via a set of judge models. The computing system 10 may determine whether the user query is answerable based on the candidate response. If the user query is not answerable, the computing system 10 may end the method 900 and output an acknowledgement to a client device 20 that the user query is unanswerable. Thus, the computing system 10 may reduce the analysis of responses to unanswerable user queries, thereby increasing the efficiency of the system and reducing resource consumption. If the user query is answerable, the computing system 10 may provide the candidate response to the set of judge models. The set of judge models may evaluate the candidate responses for various metrics, including groundedness, conciseness, relevancy, completeness, false no answer found, self-reference, formatting, citation, and the like. Thus, the computing system 10, via the set of judge models, may generate a list of error levels for the candidate response. In some embodiments, the set of judge models may perform evaluations on the responses concurrently. In some embodiments, for each metric, the computing system 10 may generate, via a categorization model, error categories based on the list of error levels. The computing system 10 may organize each error level of the list of error levels into an error category and quantify the number of error levels in each error category. Thus, the computing system 10 may group similar error levels into error categories, allowing for easy detection of repeated error levels. The computing system 10 may select the most frequent k error categories.

In process block 912, the computing system 10 may determine a training score for the candidate response based on a comparison of the candidate response to the training data of the dataset. The training score may be a numerical indicator (e.g., a percentage, a decimal, etc.) of how closely the response matches the training data. As such, a higher training score may indicate a better match between the response and the training data. In some embodiments, the computing system 10 may perform process blocks 910 and 912 in parallel or in a multithreaded manner so as to be more efficient in terms of time, computational cycles or bandwidth, and/or computational resources.

In decision block 914, the computing system 10 may determine if the validation score and the training score are within a threshold amount of each other (e.g., whether the difference between the validation score and the training score exceeds the threshold amount). For example, if the threshold amount is 0.2, the computing system 10 may determine a validation score of 0.83 and a training score of 0.91 are within the threshold amount of each other; the computing system 10 may determine a validation score of 0.56 and a training score of 0.93 are not within the threshold amount of each other. The most effective response includes both a high training score and a high validation score. The divergence of the validation score and the training score may indicate that a response has been overfit to either the training data or the validation data. By terminating the process 900 once the scores have diverged by a sufficient amount, the computing system 10 ensures the accuracy of the response and avoids outputting a prompt that is overfit to the training data.

If the validation score and training score are within the threshold amount of each other, the computing system 10 may generate an updated prompt based on the prompt and the one or more error levels in process block 916. In some embodiments, the computing system 10 may generate the updated prompt based on the prompt and the list of error levels. In some embodiments, the computing system 10 may generate the updated prompt based on the prompt and the most frequent k error categories. Such embodiments may allow the computing system 10 to prioritize addressing the most frequent error categories and prevent overwhelming or confusing the LLM.

In process block 918, the computing system 10 may generate, via the LLM, an updated response based on the updated prompt. The computing system 10 may repeat the process 900 for multiple iterations starting at process block 906. As such, the computing system 10 may generate n updated prompts and m updated responses for each prompt across all iterations. Because the updated prompt is generated to minimize the most frequent error categories with each iteration, each updated prompt may generate an increasingly accurate, comprehensive, and coherent response, and thereby improving the prompt's performance for the language model.

If the computing system 10 determines the validation score and training score are not within the threshold amount of each other, the computing system 10 may identify and store a refined prompt in process block 920. For example, the computing system 10 may identify a prompt of the prompts received and/or generated by process 900 as the refined prompt based on the validation score and/or the training score associated with the responses to each prompt (e.g., which prompt has the highest validation score and training score). Additionally, the computing system 10 may identify the refined prompt as a prompt preceding the prompt that triggered the termination of the process 900. For example, if a fourth prompt includes a response with validation score and training score that are not within the threshold amount of each other, the computing system 10 may identify a third prompt as the refined prompt. The computing system 10 may then store the refined prompt in a database. As such, the computing system 10 may store a prompt that produces accurate, comprehensive, and coherent responses while avoiding using a prompt that have been overfit to the training data.

In process block 922, the computing system 10 may deploy the refined prompt to the client device 20. The computing system 10 may be configured to receive a user query in a run-time environment. The computing system 10 may input the user query into the refined prompt to generate a response to the user query. Thus, the refined prompt may be utilized to answer the user query, reducing the likelihood of errors in the response and ensuring the computing system 10 outputs an accurate, complete, and coherent response.

Various embodiments disclosed herein are directed to a system and method for iteratively refining AI prompts autonomously. The computing system may retrieve a dataset of queries and context from a database. In some embodiments, the computing system may split the dataset into a first subset for training a model and a second subset for testing the responses of the model. The computing system may receive a first prompt. In some embodiments, the prompt may include one of the queries, the context, and instructions for instructing an LLM on how to generate a response. The computing system may provide the first prompt and the first subset of the dataset to the LLM to generate one or more responses.

The computing system may then analyze and evaluate the responses. As an example, the computing system may determine a validation score based on a comparison of the responses to the second subset of the dataset to check the accuracy of the model. In some embodiments, the computing system may analyze the responses, via a language model, to determine if the query is answerable. For example, if the computing system determines the query is unanswerable, the computing system may end the process without outputting a response. If the computing system determines the query is answerable, the computing system may analyze the responses via a set of judge models to determine one or more error levels associated with the responses. Each of the judge models may be LLMs trained to evaluate the responses for a particular metric. For example, the metrics may include formatting (e.g., markdown compliance), accuracy of citations, completeness of response, conciseness of response, groundedness (e.g., hallucination detection, accuracy of information in response), relevance to the query, self-referential statements, false No Answer Found (NAF) (e.g., incorrectly identifying no answer exists), and the like. Additionally, the computing system may determine a training score based on a comparison of the responses to the first subset of the dataset. Once the judge models have determined the error levels for each response, the computing system may provide any response with an associated error level into one or more error models. The error models may summarize each error level and organize the error levels into the error categories for each metric. The computing system may quantify the occurrences of error levels for each error category. The computing system may identify one or more categories with the most occurrences as frequent error levels.

The computing system may generate a second prompt via a prompt generation model based on the frequent error levels. In particular, the prompt generation model may be configured to generate a second prompt that mitigates the frequent error levels. The computing system may provide the second prompt and the first subset of the dataset to the LLM to generate a second one or more responses. The computing system may repeat the process (e.g., response analysis and evaluation, prompt generation) until an nth prompt outputs responses where the difference between the validation score and the training score are not within a threshold amount of each other. The computing system may then output responses associated with a prompt preceding the nth prompt to a user interface.

Technical effects of the embodiments of this disclosure may include an automated system for self-refining conversational AI prompts. As such, the system may reduce manual operations and improve the language model's performance for a variety of user queries. For example, the system may improve response accuracy, minimize hallucinations, and ensure responses are comprehensive and coherent. As an example, the system may ensure accuracy of responses and avoids overfitting responses to training data by comparing the responses to the validation data and the training data and outputting a response with relatively high values for both sets of data. By determining a response to the first prompt is within an upper limit similarity threshold of the dataset (e.g., training data, validation data, or both) and/or identifying a user query as unanswerable before submitting the response to evaluation via the set of judge models, the system may increase the efficiency of the process and reduce resource consumption. Additionally, the evaluation of each response for each metric via the set of judge models may ensure the system detects each error level in the response. The system may additionally generate error categories to encompass similar error levels and generate a new prompt based on the most frequent error categories, thereby reducing the most frequent error levels in the response to the new prompt while increasing efficiency of the system and reducing resource consumption. The process may be iterative such that the system may minimize the error levels in a response with each iteration while increasing the accuracy, comprehensiveness, and coherency of the response. As such, the system may improve the language model's performance for each user query.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
training each of a plurality of judge models to generate one or more error levels for a different respective metric of a plurality of metrics;
retrieving a user query from a dataset of user queries;
receiving a first prompt;
generating, via a language model, a candidate response based on the first prompt and the user query;
determining the plurality of error levels associated with the candidate response via the plurality of judge models, wherein each of the plurality of judge models evaluates the candidate response with respect to a different respective metric of the plurality of metrics to generate the one or more error levels of the plurality of error levels;
generating a second prompt based on the first prompt and the plurality of error levels;
generating, via the language model, an updated response based on the second prompt; and
outputting the updated response to a graphical user interface.

2. The method of claim 1, further comprising:
generating, via the language model, a plurality of candidate responses based on the first prompt and the user query; and
determining a plurality of error levels associated with each of the plurality of candidate responses via the plurality of judge models.

3. The method of claim 1, further comprising:
determining an additional plurality of error levels associated with the updated response via the plurality of judge models;
generating a third prompt based on the second prompt and the additional plurality of error levels; and
generating, via the language model, a second updated response based on the third prompt.

4. The method of claim 3, further comprising:
retrieving the dataset of user queries from a database;
determining a training score for the updated response based on a comparison of the updated response to a first subset of user queries in the dataset;
determining a validation score for the updated response based on a comparison of the updated response to a second subset of user queries in the dataset;
determining that a difference between the training score and the validation score of the updated response exceeds a threshold amount; and
storing the first prompt in a database.

5. The method of claim 1, further comprising:
retrieving the dataset of user queries from a database;
wherein generating, via the language model, the candidate response is based on the first prompt and a first subset of user queries in the dataset;
determining a training score for the candidate response based on a comparison of the candidate response to the first subset of user queries in the dataset; and
determining a validation score for the candidate response based on a comparison of the candidate response to a second subset of user queries in the dataset.

6. The method of claim 1, further comprising determining the user query is answerable via a second language model.

7. (canceled)

8. The method of claim 1, wherein the plurality of metrics comprise formatting, citation, completeness, conciseness, groundedness, relevance, self-reference, or any combination thereof.

9. The method of claim 1, wherein receiving a first prompt is via a client device.

10. The method of claim 1, further comprising outputting a representation of the first prompt to the graphical user interface.

11. The method of claim 1, wherein determining the plurality of error levels associated with the candidate response via the plurality of judge models comprises:
generating a list of error levels via the plurality of judge models;
generating a plurality of error categories;
organizing each error level of the list of error levels into an error category of the plurality of error categories; and
selecting one or more error categories, from the plurality of error categories, having the largest number of error levels.

12. A system comprising:
processing circuitry; and
a non-transitory memory, accessible by the processing circuitry and storing instructions that, when executed by the processing circuitry, cause the processing circuitry to perform operations comprising:
training each of a plurality of judge models to generate one or more error levels for a different respective metric of a plurality of metrics;
retrieving a user query from a dataset of user queries;
receiving a first prompt;
generating, via a language model, a candidate response based on the first prompt and the user query;
determining the plurality of error levels associated with the candidate response via the plurality of judge models, wherein each of the plurality of judge models evaluates the candidate response with respect to a different respective metric of the plurality of metrics to generate the one or more error levels of the plurality of error levels;
generating a second prompt based on the first prompt and the plurality of error levels;
generating, via the language model, an updated response based on the second prompt; and
outputting the updated response to a graphical user interface.

13. The system of claim 12, wherein the instructions cause the processing circuitry to perform operations further comprising:
determining an additional plurality of error levels associated with the updated response via the plurality of judge models;
generating a third prompt based on the second prompt and the additional plurality of error levels; and
generating, via the language model, a second updated response based on the third prompt.

14. The system of claim 12, wherein the first prompt and the updated prompt comprise instructions to the language model for responding to the user query.

15. (canceled)

16. The system of claim 12, wherein the plurality of metrics comprise formatting, citation, completeness, conciseness, groundedness, relevance, self-reference, or any combination thereof.

17. The system of claim 12, wherein the instructions cause the processing circuitry to perform operations comprising:
generating, via a categorization model, a plurality of error categories based on the plurality of error levels;
organizing each error level of the plurality of error levels into one of the plurality of error categories;
selecting one or more error categories, from the plurality of error categories, having the largest number of error levels; and
generating the second prompt based on the first prompt and the selected one or more error categories.

18. A non-transitory, computer readable medium comprising instructions that, when executed by processing circuitry, cause the processing circuitry to perform operations comprising:
training each of a plurality of judge models to generate one or more error levels for a different respective metric of a plurality of metrics;
retrieving a user query from a dataset of user queries;
receiving a first prompt;
generating, via a language model, a candidate response based on the first prompt and the user query;
determining the plurality of error levels associated with the candidate response via the plurality of judge models, wherein each of the plurality of judge models evaluates the candidate response with respect to a different respective metric of the plurality of metrics to generate the one or more error levels of the plurality of error levels;
generating a second prompt based on the first prompt and the plurality of error levels;
generating, via the language model, an updated response based on the second prompt; and
outputting the updated response to a graphical user interface.

19. The non-transitory, computer readable medium of claim 18, wherein the instructions cause the processing circuitry to perform operations comprising:
determining an additional plurality of error levels associated with the updated response via the plurality of judge models;
generating a third prompt based on the second prompt and the additional plurality of error levels; and
generating, via the language model, a second updated response based on the third prompt.

20. The non-transitory, computer readable medium of claim 19, wherein the instructions cause the processing circuitry to perform operations comprising:
retrieving the dataset of user queries from a database;
training the language model on a first subset of user queries in the dataset;
determining a training score for the second updated response based on a comparison of the second updated response to a first subset of user queries in the dataset;
determining a validation score for the second updated response based on a comparison of the second updated response to a second subset of user queries in the dataset;
determining that a difference between the training score and the validation score of the second updated response exceeds a threshold amount;
identifying the second prompt as a refined prompt based on a training score and a validation score of the updated response; and
storing the refined prompt in a second database to be deployed to a client device.

21. The method of claim 1, comprising:
receiving context related to the user query; and
generating, via the language model, the candidate response based on the first prompt, the user query, and the context.

22. The non-transitory, computer readable medium of claim 18, wherein the plurality of metrics comprise formatting, citation, completeness, conciseness, groundedness, relevance, self-reference, or any combination thereof.
